(19) United States
(12) Patent Application Publication
(10) Pub. No.: US 2002/0017480 A1
(43) Pub. Date: Feb. 14, 2002

(54) Process and facility for the production of ultra-pure aromatics

(76) Inventors: Gerhard Emmrich, Essen (DE); Frank Ennenbach, Eggenstein (DE); Uwe Ranke, Essen (DE); Helmut Gehrke, Beckum-Vellern (DE)

Correspondence Address: Phillip S. Oberlin, MARSHAL & MELHORN, LLC, 8th Floor, Four SeaGate, Toledo, OH, 43604, US

(21) Appl. No.: 09/916,090

(22) Filed: Jul. 26, 2001

(30) Foreign Application Priority Data
Aug. 5, 2000 (DE) 100 38 318.1

(51) Int. Cl. C10G 21/28; C10G 7/00; B01D 3/40

(52) U.S. Cl. 208/313

(57) ABSTRACT

The invention relates to a process and a facility for the production of ultra-pure aromatics with 6 to 8 carbon atoms from a hydrocarbon mixture which consists of at least one aromatic compound, an olefinic compound, a paraffinic compound or a mixture thereof and which contains impurities consisting of water-soluble organic and/or inorganic substances. An extremely high degree of purity of the product obtained by said process can be achieved with regard to impurities in the form of organic or inorganic compounds of the elements sulphur, nitrogen, oxygen and chlorine.

To this end, the aromatics are separated from the non-aromatics by means of extractive distillation and an aqueous solution 14 is dispersed in a mixing zone 12 and added to the head product 10 of the stripping column 9. The two-phase vapor 15 which is thus formed and which is laden with a mist of droplets is then transferred directly to a condensation zone 13 in which it precipitates. The condensate emulsion 16 that forms in the process is fed to a separation zone 17 in which the partial liquid phase 19 containing the ultra-pure aromatics is separated from the other partial liquid phase 22 containing dissolved impurities. The mixing zone 12 and the condensation zone 13 are accommodated in a common space, both zones being enclosed by the shell of an individual apparatus.

The invention relates to a process and a facility for the production of ultra-pure aromatic hydrocarbon compounds comprising 6 to 8 carbon atoms and containing impurities in the form of organic and inorganic compounds of the elements sulphur, nitrogen, oxygen and chlorine in the ppb range.

It has been the aim of the processing industries for many years to completely eliminate impurities from aromatic fractions. In particular, it is desirable that the aromatic hydrocarbons that are intended for further processing in chemical synthesis processes only contain minute quantities of impurities in the form of organic and inorganic compounds of the elements sulphur, nitrogen, oxygen and chlorine, these quantities being only in the ppb range, in order to permit the use of catalyst systems that are more sensitive and more selective, particularly zeolite-based catalysts. Thus, the requirement for the new catalysts used for ethyl benzene synthesis is that the maximum content of organic nitrogen compounds in benzene be limited to a maximum of 30 ppb, the ppb being referred to mass, which also applies to all ppb and ppm quantities mentioned in this document.

Pure aromatics are normally obtained by extractive distillation from hydrocarbon mixtures such as fully hydrogenated pyrolysis gasoline, coke-oven pressure raffinate or catalytic reformate gasoline. The impurities mentioned above, comprising sulphur, oxygen, nitrogen and chlorine compounds, are contained in the aromatics obtained by such extractive distillation in quantities within the ppm range. These impurities originate from residues of extraction agents or solvents or from their decomposition products, or from substances that were contained in the feedstock or which formed as a result of reactions taking place in the plant.

According to the present state of engineering technology, such impurities, if their reaction is alkaline, are removed from the aromatics after extractive distillation with the aid of acid bleaching clay. Such acid bleaching clay treatment has the following known disadvantages:

The bleaching clay has only a limited lading capacity.

The exact time of the break-through cannot be exactly predicted.

There should always be two clay towers in parallel.

The bleaching clay cannot be regenerated.

The bleaching clay has to be steamed after lading to remove the hydrocarbons.

The steamed bleaching clay has to be removed from the tower using the mining technique.

The bleaching clay has to be heat-treated to remove any residual hydrocarbons.

After such a treatment, the bleaching clay has to be dumped.

According to the present state of engineering technology, impurities that have an acid reaction are removed from the hydrocarbons with the aid of activated carbon, caustic soda or ion-exchange resins.

Regarding the addition of water to vaporous hydrocarbons, U.S. Pat. No. 4,168,209 provides for the addition of water to a distillation column for extractive distillation above the extraction agent feed point, thus condensing the head product and separating the resulting phases. In contrast to the present invention, however, the purpose of adding water is not to remove undesired constituents from the hydrocarbons but to minimise extracting agent losses, primarily within the distillation column into which the water is added. Nor does this U.S. Pat. No. 4,168,209 state what purity might be achieved. Another difference between U.S. Pat. No. 4,168,209 and the present invention is the location of the water feed point: the present invention provides for the water to be added immediately before the stream enters the condenser and not an upstream column. The present invention can thus be used independently of distillation columns and, with the purification process according to the invention, no water or aqueous solution can flow back into a column, with the result that the facility according to the invention avoids a disadvantage inherent in known facilities, in which the water is added in the upstream column.

The aim of the process according to the invention is to avoid the disadvantages of the acid bleaching clay treatment and to provide a cost-effective process for the production of ultra-pure aromatics or compound mixtures that are virtually free from impurities in the form of organic compounds of the elements sulphur, nitrogen, oxygen and chlorine, i.e. the contents of which may be in the ppb range, and to provide an improved facility for the production of such ultra-pure aromatics.

The invention is illustrated here using as an example the extractive distillation process described, for instance, in “MORPHYLANE—Production of ultra-pure aromatics”, a pamphlet published in 1000 copies by the applicant, Krupp Uhde GmbH, in May 1997, and which uses N-formylmorpholine (NFM) as the extraction agent. The process according to the invention is, however, not limited to processes using this extraction agent, but can be combined with other processes using different extraction agents or solvents, such as N-methyl pyrrolidone or tetramethyl sulphone (Sulfolan®). The example describes the production of ultra-pure benzene, but can be used without any restrictions for the production of aromatics with up to 8 carbon atoms and mixtures thereof and should be understood in this context.

The extractive distillation process quoted as an example usually comprises an extractive distillation column and a downstream stripping column, although the two columns can also be structurally combined and integrated into one single unit as described in DE 198 49 651. Furthermore, a pre-distillation column can be connected upstream of the extractive distillation column in order to be able to feed heavy and light ends to different trays of the extractive distillation column. In the extractive distillation column, the benzene is washed out of the feedstock, in this example a so-called benzene fraction consisting of a mixture of benzene and non-aromatic components, by means of a selective solvent, N-formylmorpholine in this particular case. The non-aromatic components are stripped overhead, the benzene and the solvent flowing to the bottom of the column. The benzene and the solvent are separated in the downstream stripping column. The stripped solvent collects in the stripping column bottom and is pumped back to the extractive distillation column head for re-use. The benzene leaves the stripping column head in vaporous state. The residual solvent content averages 1 ppm N-formylmorpholine or 1 ppm of the hydrolysis product “morpholine”.

In a mixing zone, an aqueous solution is directly dispersed into this benzene vapour, e.g. by injection. The water content of the solution—referred to the benzene vapour—can be in the range from 1%-wt. to 20%-wt., the preferred content being 5%-wt. Part of the aqueous solution evaporates in this process so that heat is extracted from the benzene vapour, as a result of which part of the benzene condenses and separates from the vapour phase and mixes thoroughly with the droplets of the injected aqueous solution. A first portion of the undesired components thus migrates from the benzene phase to the aqueous phase in which they dissolve more readily in accordance with their ratio of their solubilities.

A two-phase vapour is thus formed, i.e. a vapour laden with a mist of droplets. Its gaseous phase basically comprises the vapour of the benzene feedstock and water vapour. Its liquid phase primarily comprises the mist of water droplets from the injected aqueous solution with the impurities dissolved therein. The reason why the liquid phase does not mainly consist of benzene, which has a lower boiling point than water, is that the evaporation of the water droplets at temperatures within the range of the boiling temperature of the carbon compound involved is a relatively slow process and that the retention time of the water droplets is relatively short. However, if the aqueous solution is injected into a hydrocarbon feedstock that is to be purified and consists, for instance, mainly of toluene with a boiling point of 110° C. or primarily of a mixture of ethyl benzene and xylenes with a boiling point ranging from 131° C. to 144° C., then the two-phase vapour will have a temperature above the boiling point of water and, consequently, the hydrocarbon portion in the mist of droplets will in this case be predominant. The vapour laden with a mist of droplets is sent directly from the mixing zone to a condensation zone. In the condensation zone, both phases are brought into contact with cooling surfaces, where they condense and are thus converted to a condensed liquor obtained as an emulsion of one of the liquids in the other liquid.

Thorough mixing of the two phases again takes place in the condensation zone, as a result of which the remaining portion of the impurities can migrate from the benzene phase into the aqueous phase in which the remaining impurities dissolve more readily on account of the ratio of their solubilities at a mass transfer resistance kept as low as possible. The condensed liquor that forms in the condensation zone consists of a liquid phase system one part of which primarily contains benzene and the other part of which mainly contains the solution water. The condensed liquor is withdrawn from the condensation zone and fed to a separation zone.

In the separation zone, the partial liquid phase mainly containing benzene is separated from the other partial liquid phase mainly containing the solution water with the impurities dissolved therein. The separation of the one liquid from the other liquid takes place by making use of the different specific gravities of the two partial liquid phases, e.g. by gravity or centrifugal force or other comparable means. The present invention therefore provides for a water separating device used to remove the one partial liquid phase of emulsion that primarily contains purified benzene from the other partial liquid phase of emulsion that primarily contains the solution water.

The benzene phase is purified and, if it is required to be anhydrous for its future utilisation, it must be dried. The aqueous phase is normally, but not necessarily, split into two part streams. One of these part streams is treated biologically and then processed for disposal. The other part stream is returned to the injection point and thus constitutes a cycle. The ratio of the two part streams is determined on the basis of the content of dissolved impurities and the purity specified for the particular product benzene. The specialist involved will perform laboratory tests to this end. If the max. admissible load is exceeded this could mean that only clean water may be injected and that the aqueous phase removed in the water separating device has to be completely processed for disposal. A further embodiment of the invention, therefore, provides for the recycling of at least part of the solution water separated from the emulsion, said part being returned to the mixing zone mentioned above where it is dispersed as part of the aqueous solution and it likewise provides for the withdrawal and disposal of the impurities being entrained in the remaining part of the solution water separated from the emulsion, thus eliminating said impurities from the solution water cycle.

The advantageous implementation of the process according to the invention is described in more detail using, as an example, an extractive distillation system for the production of ultra-pure benzene with the aid of the nitrogen-bearing extraction agent N-formylmorpholine, the implementation being, of course, not limited to extractive distillation systems or to the removal of N-formylmorpholine or the purification of benzene.

The extractive distillation process used as an example normally comprises two columns, i.e. an extractive distillation column and a downstream stripping column. Said columns may also be combined in a divided wall column or a graduating column. In the first column, i.e. the extractive distillation column, the benzene is washed out of the feed product, a benzene fraction in this case, by means of a selective solvent, N-formylmorpholine in this case. The non-aromatic components are overhead stripped, the benzene and the solvent flowing to the bottom of the column and being separated in the second column, i.e. the stripping column. The stripped solvent collects in the bottom of the stripping column and is pumped back to the extractive distillation column head for re-use. The benzene leaves the stripping column head in vaporous form. According to the present state of the art, it is then condensed and collected in the reflux vessel in order to be pumped as reflux to the stripping column. The remaining benzene is piped as finished product to battery limit. The residual solvent content according to the conventional state of the art averages 1 ppm (i.e. 1000 ppb) N-formylmorpholine (NFM) or 1 ppm of the hydrolysis product “morpholine”, 1/7 of both these substances consisting of nitrogen referred to their mass.

The process according to the invention surprisingly permits the reduction of the nitrogen content in the finished product to less than 30 ppb by injecting solution water, preferably with formic acid, these substances being simultaneously injected into the benzene vapour stream from the stripping column head immediately upstream of the condenser. The reason for this phenomenon is that the distribution factor in the ternary system NFM/morpholine-benzene-water is 30 times greater for NFM/morpholine-water than for NFM/morpholine-benzene. The solubility of water in benzene and of benzene in water is very low (at 50° C.: 1.3 g benzene/1000 g water and 1.56 g water/1000 g benzene). Hence, following a thorough mixing process, a phase separation takes place and the NFM solvent is contained in the aqueous phase. The process according to the invention thus has the convincing advantage that the production of an ultra-pure product is feasible with the aid of simple means.

Another embodiment of the invention provides for a further increase of the product purity, in that at least part of the aqueous solution dispersed in the mixing zone consists of clean water.

A further embodiment of the invention provides for the pH value of the recycled aqueous solution being adjusted to a value slightly over 7, say 7.5, by adding acid, for instance, formic acid, in order to remove the nitrogen compounds already present as salt in the recycled water from the solution equilibrium. To this end, an acid is admixed to the aqueous solution dispersed into the mixing zone. The process according to the invention provides for the use of formic acid as the acid admixed to the aqueous solution.

Yet another embodiment of the invention provides for the removal of the salts precipitated in the aqueous solution after the addition of acid with the aid of precipitants.

A further embodiment of the invention provides for the admixing of acid being pH-controlled.

A special embodiment of the invention provides for cooling of the aqueous solution before it is dispersed into the mixing zone.

Another embodiment of the invention provides for the condensate emulsion that forms in the condensation zone being subcooled prior to being fed to the separation zone.

The invention also provides for a facility suited to carry out the process according to the invention. As described above, the process according to the invention provides for dispersing the aqueous solution into the benzene vapour immediately upstream of the condenser, e.g. by injection. It was found that it is particularly effective with regard to the achievable product purity to combine the mixing zone and the condensation zone directly in an integral apparatus, thus avoiding any transfer lines between the two process steps. Hence, an embodiment of the facility according to the invention comprises a single apparatus in which the mixing zone and the condensation zone are arranged within a common space, said space being enclosed by the shell of said single apparatus.

The process is also suitable for installation in existing plants, because in most cases the reflux vessels in fractionation, extraction and extractive distillation units are equipped with water separation devices or can be retrofitted with such devices at low cost.

The pure product obtained which is free from impurities is water-saturated (water in benzene at 50° C.: 1.56 g/1000 g). If the product has to be anhydrous for use in downstream synthesis processes, a distilling or absorptive drying step can easily be arranged downstream.

The process according to the invention is illustrated and described in more detail on the basis of the example shown in the attached drawing.

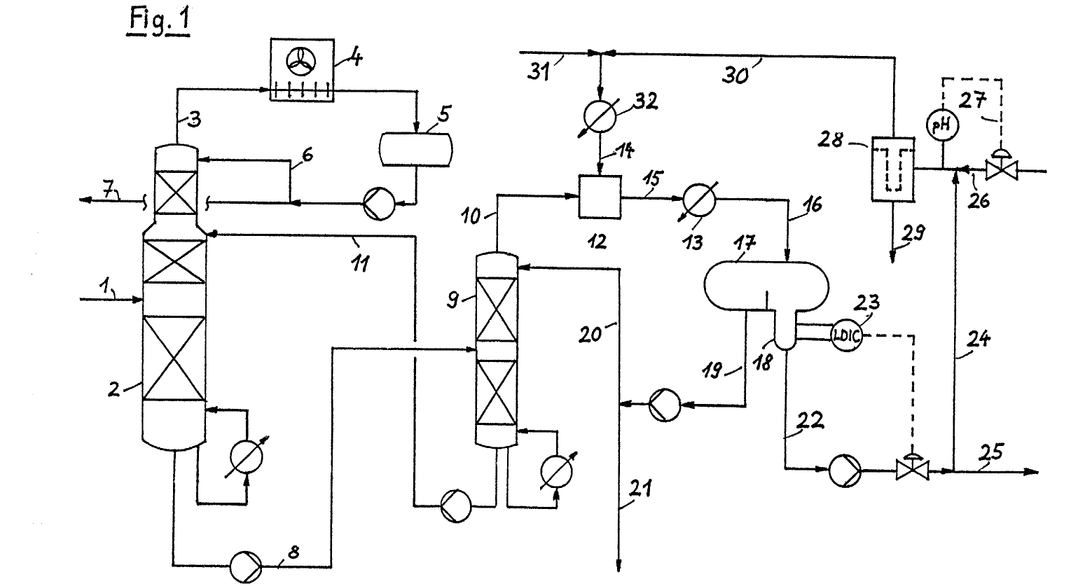

FIG. 1 shows the process flow diagram of a plant for the production of ultra-pure benzene

The purification of the feed fraction 1 is performed by extractive distillation using two columns, the extractive distillation column 2 and the stripping column 9. N-formylmorpholine is used as the solvent. The feed fraction, which contains both aromatics and non-aromatics, is fed to the extractive distillation column 2 via line 1. The feed fraction may consist of various hydrocarbon mixtures containing benzene, toluene and xylene, such as coke-oven benzene pressure raffinate, pyrolysis gasoline or reformate gasoline. The separation of the aromatics from the non-aromatics takes place in the extractive distillation column 2 which can be equipped with trays and other internals or which can be designed as graduating column, the required solvent (e.g. N-formylmorpholine) being fed to the extractive distillation column 2 via line 11. In this process, the solvent and the aromatics (as an extract) are withdrawn from the bottom of the extractive distillation column 2 and flow via line 8 into the stripping column 9. The non-aromatics are simultaneously withdrawn in vaporous state from the column head via line 3, condensed in the air cooler 4, collected in the reflux vessel 5, one part being recycled via line 6 to the extractive distillation column 2 and the other part being fed to further treatment facilities via line 7.

The mixture of benzene and solvent from the extractive distillation column 2 is fed via line 8 to. the stripping column 9. The separation of benzene and solvent takes place in the stripping column 9, the vaporous benzene head product being withdrawn from the stripping column 9 via line 10. The head product contains impurities, such as traces of the solvent. The benzene-free solvent is removed from the bottom of stripping column 9 and recycled via line 11 to the extractive distillation column.

Immediately before the benzene vapours enter the condenser 13, an aqueous solution 14 is injected into the mixing zone 12, which is designed as spraying device. The aqueous solution 14 is a mixture of deionised water, water vapour condensate, recycled aqueous solution and formic acid. This aqueous solution partly evaporates in the mixing zone 12, the energy extracted from the benzene vapour causing partial condensation of the benzene in line 15. The evaporated aqueous solution and the residual benzene vapour condense and precipitate, together with the already condensed droplets, in the downstream condenser 13. Thorough mixing of the benzene and the aqueous solution takes place during the partial condensation downstream of the injection point for the aqueous solution in mixing zone 12 as well as in condenser 13. In this process step, the aqueous solution removes most of the impurities from the condensed liquor.

The condensed benzene as well as the aqueous solution flow via line 16 to the reflux vessel 17 which is equipped with a water separating device 18. The purified benzene is withdrawn via line 19, a partstream of which is returned via line 20 to the stripping column 9, the remaining partstream being withdrawn as product benzene 21 from the purification unit. The remaining impurities are dissolved in the aqueous solution in reflux vessel 17. The aqueous solution 22 is evacuated from the separation device 18 via a two-phase controller 23, a partstream being pumped back via line 24 to the injection input upstream of the condenser. The other partstream of the aqueous solution 22 is transferred as waste water via line 25 to a biological waste water treatment unit. The ratio of these two streams in lines 24 and 25 is determined on the basis of the content of the impurities dissolved in the aqueous solution and the particular benzene purity specified. The solubility equilibria of the impurities for the phase of the aqueous solution and for the phase of the benzene have to be taken into consideration. A specialist involved will carry out laboratory tests for this purpose. It may be found in individual cases that only clean water may be injected via line 14 and that the aqueous solution (22) separated in reflux vessel 17 has to be completely processed for disposal.

To set a pH value of 7 to 7.5, formic acid 26 is mixed in line 24 with the aqueous solution to be injected, the formic acid feed rate being controlled by a pH controller 27. As a result of reducing the pH value, a solvent salt 29 precipitates and is subsequently removed from the aqueous solution in filter 28. This method prevents any enrichment of the impurities already separated in the aqueous solution. Water from the clean water line 31 is added via line 30 to the aqueous solution in order to make up for the cycle water that leaves the purification unit via line 25, either dissolved in the product benzene 21 or in the form of waste water. In order to intensify the condensation effect in mixing zone 12, the aqueous solution may, if and when required, be cooled in water cooler 32.

1. Process for the separation of hydrocarbon mixtures containing aromatic compounds with 6 to 8 carbon atoms by extractive distillation with the aid of selective solvents or solvent mixtures, the feed product entering into the central part and the solvent being fed into the upper part of a column for extractive distillation, the lower boiling hydrocarbons of the feed product in the solvent/hydrocarbon mixture being withdrawn at the head of said column used for extractive distillation, while the higher boiling hydrocarbons of the feed product are withdrawn together with the main portion of the solvent from the bottom of the extractive distillation column, the bottom product from the extractive distillation column being piped to a column used for stripping the solvent and arranged downstream of the column for extractive distillation, the column for stripping the solvent not necessarily being separated from the column for extractive distillation,
characterised in that an aqueous solution is dispersed in a mixing zone and added to the vaporous head product from the column used for stripping the solvent, the two-phase vapour thus formed and laden with a mist of droplets being directly sent to a condensation zone in which it is precipitated simultaneously with both phases, and the condensate emulsion thus formed being fed to the separation zone, in which the one partial liquid phase of said emulsion primarily containing purified hydrocarbon is separated from the other partial liquid phase primarily containing solution water with the impurities dissolved therein.

2. Process according to claim 1,
characterised in that the separation of the partial liquid phase of the emulsion, which primarily contains purified aromatic hydrocarbons, from the other partial liquid phase of the emulsion, which primarily contains solution water, is accomplished by means of a water separating device.

3. Process according to any one of the preceding claims 1 or 2,
characterised in that at least part of the solution water separated from the emulsion is recycled and dispersed as part of the aqueous solution into said mixing zone and that the impurities are eliminated from the solution water cycle with the remaining part of the solution water separated from the emulsion and sent to disposal facilities.

4. Process according to any of the preceding claims 1 to 3,
characterised in that at least part of the aqueous solution dispersed into the mixing zone consists of clean water.

5. Process according to any of the preceding claims 1 to 4,
characterised in that an acid is admixed to the aqueous solution dispersed into the mixing zone.

6. Process according to claim 5 above,
characterised in that the acid admixed to the aqueous solution is formic acid.

7. Process according to any one of the preceding claims 5 or 6,
characterised in that the salts precipitated after admixing acid to the aqueous solution are removed from the aqueous solution with the aid of precipitants.

8. Process according to any of the preceding claims 5 to 7,
characterised in that the acid admixture is pH-controlled.

9. Process according to any of the preceding claims 1 to 8,
characterised in that the aqueous solution is cooled prior to being dispersed into the mixing zone.

10. Process according to any of the preceding claims 1 to 9,
characterised in that the condensate emulsion that forms in the condensation zone is subcooled prior to being fed to the separation zone.

11. Facility for the performance of the process according to at least one of the preceding claims 1 to 10,
characterised in that the mixing zone and the condensation zone are arranged in a common space enveloping the two zones and that this space is enclosed in the shell of a single apparatus.
